(19) United States
(12) Patent Application Publication
(10) Pub. No.: US 2008/0218120 A1
(43) Pub. Date: Sep. 11, 2008

(54) CHARGE RECOVERY DEVICE FOR ALKALINE BATTERIES

(76) Inventor: Yi-Jang Yeh, Tainan City (TW)

Correspondence Address: DARBY & DARBY P.C., P.O. BOX 770, Church Street Station, New York, NY, 10008-0770, US

(21) Appl. No.: 11/830,055

(22) Filed: Jul. 30, 2007

(30) Foreign Application Priority Data
Mar. 6, 2007 (TW) 096107649

(51) Int. Cl. H02J 7/00

(52) U.S. Cl. 320/107

(57) ABSTRACT

A charge recovery device includes: a battery seat to be connected electrically to an alkaline battery load; a power source connector to be connected electrically to an external power source; a charging signal generator connected electrically to the power source connector and operable to generate a charging signal output that can be varied to meet voltage requirement of the alkaline battery load; a safety switch for making or breaking electrical connection between the battery seat and the charging signal generator; a timer unit operable to initiate a timer operation upon supply of the charging signal output to the battery seat; and a switch controller for controlling the safety switch to break electrical connection between the battery seat and the charging signal generator at the end of a charging period according to a timer signal received from the timer unit.

### CROSS-REFERENCE TO RELATED APPLICATION

This application claims priority of Taiwanese application no. 096107649, filed on Mar. 6, 2007.

### BACKGROUND OF THE INVENTION

1. Field of the Invention

The invention relates to a charge recovery device, more particularly to a charge recovery device for alkaline batteries.

2. Description of the Related Art

Many electronic products rely on batteries as a source of power. While alkaline batteries are common, they contain highly polluting chemical substances and heavy metals such that disposal of the same has a detrimental effect on the environment. In recent years, many government agencies and environment protection organizations have actively pursued battery recycling. While it is feasible to recharge alkaline batteries for reuse, different alkaline batteries are made of different materials. For example, different alkaline batteries may employ different metal material combinations, such as carbon-zinc, zinc-manganese, etc. Due to the different materials used by the alkaline batteries, distinctive characteristics and charging conditions result. If an improper charging voltage is applied when recharging an alkaline battery, a chemical change in internal materials of the alkaline battery can occur, which can lead to overheating and danger. For this reason, battery manufacturers do not recommend consumers to recharge alkaline batteries on their own, and therefore categorize alkaline batteries as non-rechargeable batteries. Hence, the applicant is unaware of a device currently available to consumers for recharging alkaline batteries.

There is a need in the art to provide a device that can be used to recharge alkaline batteries such that the latter can be reused to reduce pollution and to make alkaline batteries more environmental friendly.

### SUMMARY OF THE INVENTION

Therefore, the object of the present invention is to provide a charge recovery device for recharging alkaline batteries.

Accordingly, a charge recovery device of this invention is adapted for charging an alkaline battery load using an external power source, and comprises a battery seat, a power source connector, a charging signal generator, a safety switch, a timer unit, and a switch controller.

The battery seat is adapted for receiving the alkaline battery load therein and for connecting electrically to the alkaline battery load.

The power source connector is adapted for connecting electrically to the external power source.

The charging signal generator is connected electrically to the power source connector, and is operable to generate a charging signal output that can be varied to meet voltage requirement of the alkaline battery load.

The safety switch is connected electrically to the battery seat and the charging signal generator, and is operable to make or break electrical connection between the battery seat and the charging signal generator.

The timer unit is operable to initiate a timer operation upon supply of the charging signal output from the charging signal generator to the battery seat via the safety switch.

The switch controller is connected electrically to the safety switch and the timer unit, receives a timer signal from the timer unit, and is operable to control the safety switch to break electrical connection between the battery seat and the charging signal generator at the end of a charging period.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of the preferred embodiment of a charge recovery device according to the present invention; and

FIG. 2 is a flowchart to illustrate a charge recovery operation of the preferred embodiment.

### DETAILED DESCRIPTION OF THE PREFERRED EMBODIMENT

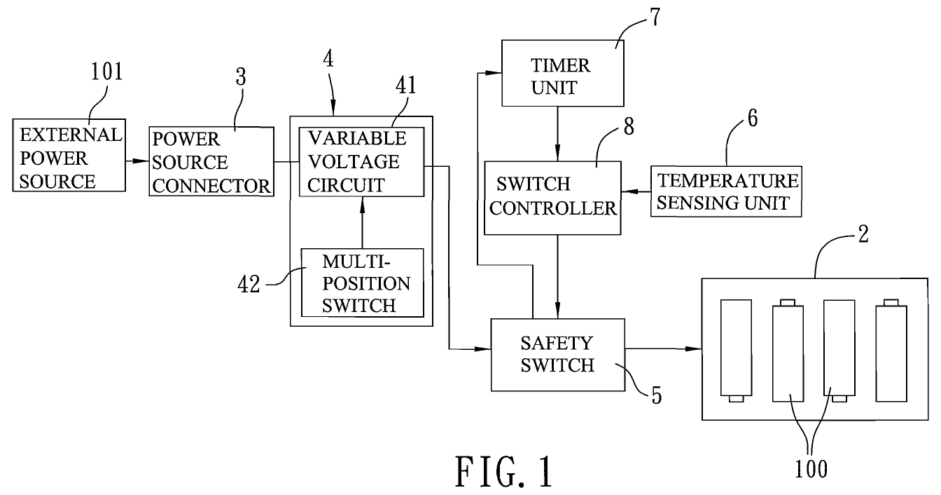

Referring to FIG. 1, the preferred embodiment of a charge recovery device according to the present invention is adapted for charging an alkaline battery load using an external power source 101, and includes a battery seat 2, a power source connector 3, a charging signal generator 4, a safety switch 5, a temperature sensing unit 6, a timer unit 7, and a switch controller 8. The external power source 101 may be a commercial AC power source or a DC power source. In this embodiment, the external power source 101 is a commercial AC power source for illustrative purposes.

The battery seat 2 is adapted for receiving the alkaline battery load therein and for connecting electrically to the alkaline battery load. In this embodiment, the alkaline battery load includes a plurality of alkaline cells 100, and the battery seat 2 is adapted for interconnecting electrically in series the alkaline cells 100 of the alkaline battery load received therein.

The power source connector 3 is adapted for connecting electrically to the external power source 101.

The charging signal generator 4 is connected electrically to the power source connector 3, and is operable to generate a charging signal output that can be varied to meet voltage requirement of the alkaline battery load. In this embodiment, the charging signal generator 4 may be disposed in the battery seat 2, and includes a variable voltage circuit 41 for generating the charging signal output that meets the voltage requirement of the series-connected alkaline cells 100 of the alkaline battery load, and a multi-position switch 42 exposed from the battery seat 2, connected electrically to the variable voltage circuit 41, and operable to set the charging signal output of the variable voltage circuit 41. In particular, by disposing the multi-position switch 42 at a selected position, the variable voltage circuit 41 can be controlled such that the magnitude of the DC charging voltage of the charging signal output thus generated corresponds to the selected position of the multi-position switch 42.

The variable voltage circuit 41 is operable such that the DC charging voltage of the charging signal output is a selected integer multiple of a preset voltage value, and the selected integer multiple is selected through the multi-position switch 42. In this embodiment, the battery seat 2 is configured to interconnect electrically in series up to four AA manganese alkaline cells 100. The preset voltage value ranges from 1.71 volts to 2.03 volts, which is the ideal charging voltage range for a AA manganese alkaline cell 100. The integer multiple available for selection through the multi-position switch 42 ranges from 1 to 4, such that the charge recovery device is suitable for charging from one to four AA manganese alkaline cells 100. Therefore, assuming that the preset voltage value is 1.71 volts, 1.71 volts, 3.42 volts, 5.13 volts and 6.84 volts are available for selection as the DC charging voltage of the charging signal output of the variable voltage circuit 41. For instance, if three AA manganese alkaline cells 100 are to be recharged, the multi-position switch 42 is operated for setting the DC charging voltage of the charging signal output of the variable voltage circuit 41 to 5.13 volts. Accordingly, if four AA manganese alkaline cells 100 are to be recharged, the multi-position switch 42 is operated for setting the DC charging voltage of the charging signal output of the variable voltage circuit 41 to 6.84 volts.

It should be noted herein that the number of alkaline cells 100 that can be received in the battery seat 2, and the type of the alkaline cells 100 suitable for recharging by the charge recovery device of this invention are not limited to the above example. In addition, it is possible to vary the number of positions of the multi-position switch 42 and the available DC charging voltages of the charging signal output of the variable voltage circuit 41 according to requirements.

The safety switch 5 is connected electrically to the battery seat 2 and the variable voltage circuit 41 of the charging signal generator 4, and is operable to make or break electrical connection between the battery seat 2 and the variable voltage circuit 41 of the charging signal generator 4.

The timer unit 7 is connected electrically to the safety switch 5, and is operable to initiate a timer operation upon supply of the charging signal output from the charging signal generator 4 to the battery seat 2 via the safety switch 5. In this embodiment, the timer unit 7 is disposed in the battery seat 2, has information of a charging period set therein, and provides a timer signal at the end of the charging period. The charging period may be set to 60 minutes but should not be limited thereto. In addition, the timer circuit 7 stops the timer operation thereof when the safety switch 5 breaks the electrical connection between the charging signal generator 4 and the battery seat 2.

The temperature sensing unit 6 is disposed on the battery seat 2, is adapted for detecting temperature of the alkaline battery load, is connected electrically to the switch controller 8, and provides a detected temperature signal corresponding to the temperature detected thereby to the switch controller 8.

The switch controller 8 is connected electrically to the safety switch 5 and the timer unit 7, receives the timer signal from the timer unit 7, and is operable to control the safety switch 5 to break electrical connection between the battery seat 2 and the charging signal generator 4 at the end of the charging period. The switch controller 8 is further operable to control the safety switch 5 to break the electrical connection between the charging signal generator 4 and the battery seat 2 according to the detected temperature signal from the temperature sensing unit 6 when the temperature of the alkaline battery load exceeds a safety threshold.

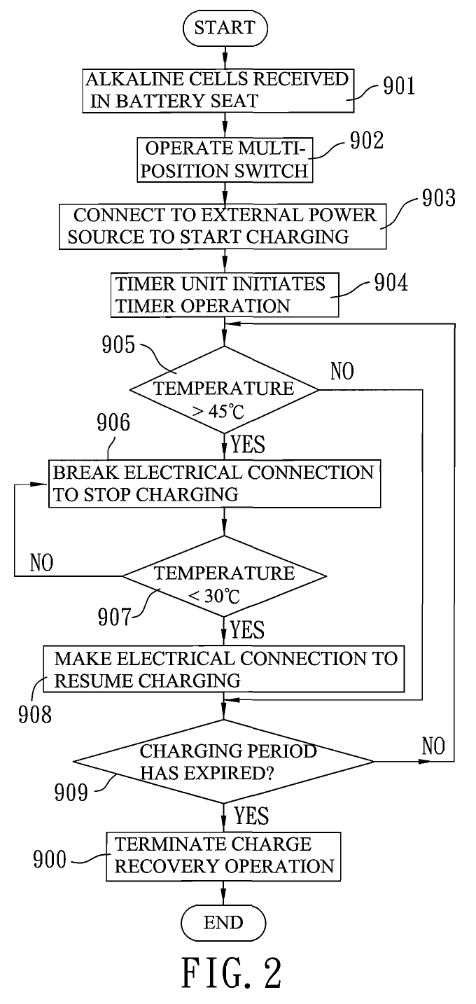

FIG. 2 is a flowchart to illustrate a charge recovery operation for alkaline cells 100 performed by the charge recovery device of this invention.

Initially, in step 901, the alkaline cells 100 that are to be recharged are received in and are interconnected electrically in series by the battery seat 2. Next, in step 902, the multi-position switch 42 is operated to select an integer multiple corresponding to the number of the alkaline cells 100 received in the battery seat 2, thereby setting the DC charging voltage of the charging signal output of the variable voltage circuit 41. Then, in step 903, the power source connector 3 is connected electrically to the external power source 101 such that the variable voltage circuit 41 generates the charging signal output for the alkaline cells 100 from electricity supplied by the external power source 101. At this time, the safety switch 5 makes electrical connection between the battery seat 2 and the variable voltage circuit 41 of the charging signal generator 4 so that the charging signal output with the selected DC charging voltage from the variable voltage circuit 41 is supplied to the battery seat 2 via the safety switch 5, thereby starting recharging of the alkaline cells 100. In step 904, the timer unit 7 initiates its timer operation.

Thereafter, in step 905, the temperature sensing unit 6 continuously detects the temperature of the alkaline cells 100, and provides the detected temperature signal corresponding to the temperature detected thereby to the switch controller 8. If the switch controller 8 determines from the detected temperature signal that the temperature of the alkaline cells 100 does not exceed the safety threshold, which is 45° C. in this embodiment, the flow goes to step 909. Otherwise, the flow goes to step 906. In step 906, the switch controller 8 controls the safety switch 5 to break the electrical connection between the variable voltage circuit 41 of the charging signal generator 4 and the battery seat 2 so as to stop charging of the alkaline cells 100. The timer unit 7 stops the timer operation thereof at this time. Subsequently, in step 907, the switch controller 8 determines from the detected temperature signal provided by the temperature sensing unit 6 if the temperature of the alkaline cells 100 has fallen below a low temperature threshold, which is 30° C. in this embodiment. If negative, the flow goes back to step 906. Otherwise, the flow goes to step 908. In step 908, the switch controller 8 controls the safety switch 5 to make electrical connection between the variable voltage circuit 41 of the charging signal generator 4 and the battery seat 2 so as to resume charging of the alkaline cells 100. The timer unit 7 initiates a new timer operation at this time.

In this embodiment, the safety threshold is set to 45° C., whereas the low temperature threshold is set to 30° C. The temperature range of from 30° C. to 45° C. is an ideal charging temperature range for manganese alkaline cells. In practice, the actual values of the safety threshold and the low temperature threshold may vary depending on the type of the alkaline cells 100 and should not be limited to those described above.

In step 909, the switch controller 8 determines from the timer signal of the timer unit 7 if the charging period has expired. If yes, the flow goes to step 900, where the switch controller 8 controls the safety switch 5 to break the electrical connection between the variable voltage circuit 41 of the charging signal generator 4 and the battery seat 2 to end the charge recovery operation for the alkaline cells 100. Otherwise, the flow goes back to step 905.

In this embodiment, the temperature sensing unit 6 is included to prevent overheating of the alkaline cells 100 during the charge recovery operation. In addition, when the charge recovery device of this invention is used to charge an incompatible type of battery cell having a different charging voltage requirement, because the charging signal output of the charging signal generator 4 does not correspond to the voltage requirement of the incompatible battery cell, the temperature of the incompatible battery cell can easily exceed the safety threshold during the charge recovery operation. Due to the inclusion of the temperature sensing unit 6, the temperature during charge recovery can be monitored so as to ensure safety even when incompatible battery cells are recharged. It is noted that when the charge recovery device of this invention is designed for an environment capable of real-time detection of ambient temperature, such as a factory capable of temperature detection through infrared, the temperature sensing unit 6 may be omitted.

Moreover, the battery seat 2 may be designed to receive a single alkaline cell 100, which eliminates the need for the multi-position switch 42. The multi-position switch 42 may be a rotary type, a push button type or a lever type. Furthermore, while the charging signal generator 4 and the power source connector 3 are disposed on the battery seat 2 in the preferred embodiment, it is possible to design them to be removably connected to the battery seat 2 in other embodiments of this invention.

In sum, the charging signal generator 4 of the charge recovery device of this invention is operable to generate a charging signal output that can be varied to meet the voltage requirement of an alkaline battery load. Moreover, the temperature sensing unit 6 of the charge recovery device can monitor the temperature of the alkaline battery load to prevent overheating during a charge recovery operation. The charge recovery device of this invention permits alkaline cells 100 to be reusable, thereby reducing pollution and making alkaline batteries more environmental friendly.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A charge recovery device adapted for charging an alkaline battery load using an external power source, said charge recovery device comprising:
a battery seat adapted for receiving the alkaline battery load therein and for connecting electrically to the alkaline battery load;
a power source connector adapted for connecting electrically to the external power source;
a charging signal generator connected electrically to said power source connector and operable to generate a charging signal output that can be varied to meet voltage requirement of the alkaline battery load;
a safety switch connected electrically to said battery seat and said charging signal generator and operable to make or break electrical connection between said battery seat and said charging signal generator;
a timer unit operable to initiate a timer operation upon supply of the charging signal output from said charging signal generator to said battery seat via said safety switch; and
a switch controller connected electrically to said safety switch and said timer unit, receiving a timer signal from said timer unit, and operable to control said safety switch to break electrical connection between said battery seat and said charging signal generator at the end of a charging period.

2. The charge recovery device as claimed in claim 1, wherein said timer unit is disposed in said battery seat, has the charging period set therein, and provides the timer signal to said switch controller at the end of the charging period.

3. The charge recovery device as claimed in claim 1, the alkaline battery load including a plurality of alkaline cells, wherein said battery seat is adapted for interconnecting electrically in series the alkaline cells of the alkaline battery load received therein, said charging signal generator including a variable voltage circuit for generating the charging signal output that meets the voltage requirement of the series-connected alkaline cells of the alkaline battery load.

4. The charge recovery device as claimed in claim 3, wherein said charging signal generator further includes a multi-position switch connected electrically to said variable voltage circuit and operable to set the charging signal output of said variable voltage circuit.

5. The charge recovery device as claimed in claim 4, wherein said variable voltage circuit is operable such that a voltage of the charging signal output is a selected integer multiple of a preset voltage value, the preset voltage value ranging from 1.71 volts to 2.03 volts, the selected integer multiple being selected through said multi-position switch.

6. The charge recovery device as claimed in claim 1, further comprising a temperature sensing unit disposed on said battery seat, adapted for detecting temperature of the alkaline battery load, connected electrically to said switch controller, and providing a detected temperature signal corresponding to the temperature detected thereby to said switch controller, said switch controller being further operable to control said safety switch to break the electrical connection between said charging signal generator and said battery seat according to the detected temperature signal when the temperature of the alkaline battery load exceeds a safety threshold.

7. The charge recovery device as claimed in claim 1, wherein said timer unit stops the timer operation thereof when said safety switch breaks the electrical connection between said charging signal generator and said battery seat.
